(19) United States
(12) Patent Application Publication
(10) Pub. No.: US 2015/0356619 A1
(43) Pub. Date: Dec. 10, 2015

(54) SYSTEM FOR DIRECTING, MANAGING AND DISPLAYING ADVERTISEMENT ON SMART MOBILE PHONES

(71) Applicant: Hasan Kasif ATAMGAZI, (US)

(72) Inventor: Hasan Atamgazi, Istanbul (TR)

(21) Appl. No.: 14/761,945

(22) PCT Filed: Jan. 20, 2014
(86) PCT No.: PCT/TR2014/000012

§ 371 Date: Jul. 18, 2015

(30) Foreign Application Priority Data
Jan. 23, 2013 (TR) 2013/00809

(51) Int. Cl. G06Q 30/02; H04W 4/00; H04M 3/42; H04M 3/487

(52) U.S. Cl. CPC G06Q 30/0267; H04M 3/4878; H04W 4/003; H04M 3/42051

(57) ABSTRACT

The invention is a system for directing, managing and displaying advertisements on mobile phones wherein an audio and/or video advertisement/message replaces available ringtones and notification tones through a system application which is downloaded on/installed on/transmitted to the mobile phone of the users, ensuring that phone of a user that receives a call/message plays/runs audio and/or video advertisements/messages without any intervention by the user, and the user turns his/her phone into a new channels thus earning money/credit/advantage for himself or for other third parties.

### TECHNICAL FIELD WHICH THE INVENTION BELONGS TO

The invention relates to a system for directing, managing and displaying advertisements on smart phones. The invention creates value by introducing audio/video advertisements/messages instead of ring or notification tones of the phone, without intervention by the member, when a system user who uses a smart phone is called and/or notified by others (through an application which the user downloaded and installed on his/her phone or an application of the system to which the user is directed). In application of the invention, there are three parties involved namely the smart mobile phone user, the advertiser, and the service provider that enables those two parties to meet on the display of user's mobile phone.

### TECHNICAL PROBLEMS WHICH THE INVENTIONS AIMS AT SOLVING

Presently, mobile phones are one of our most used personal items. As the smart phones have become widespread, in particular, the mobile phones have evolved from plain talking and communication tools into personal items which meet most of our needs.

Mobile phones which have turned into frequently used personal items have become a channel which the advertisers and marketers can use for sending their advertisements/messages and notifications. Short messages, voice messages, messages on programs, advertisements in applications are examples of these solutions. The users can configure to personalize their ringtones. Moreover, it is also possible to load customer-oriented advertisements to other solutions.

However, all these methods have 2 problems. The first of them is that the mobile phone owner or user does not receive any incomes from advertisements on the mobile phone, which is a completely personal product, through ringtone or notification advertisements on the personal device of the user. However, the advertisement channel belongs to and is used by the user yet the user has no control over the advertisements displayed on his/her personal device, and the user receives no income. The method covered by the invention brings a solution to this problem.

The second most important problem is that all of the advertisements displayed require intervention by the user. The person will personally change the ringtone or notification tone every time or at certain intervals, or watch or listen to the advertisements by intervening in the mobile phone. However, with the method covered under the invention, a person who once installs an application watches or listens to, as well as have anybody around watch and listen to advertisements, which can be loaded, changed or deleted by the service provider, without any intervention, when the user's phone rings or a notification received. Everybody nearby are also exposed to such advertisements or notification/information messages. This application is a system and method whereby the advertisement channel created for making the mobile phone user gain money/advantages can be managed, displayed and organized without intervention by the user, and it is a method which solves all of the foregoing problems.

For the advertisers, it is very important that the advertisement and the consumer meet without control of the consumer. Methods which offer making money by watching advertisements on demand do not appeal to the advertiser because the user makes an intervention to watch such advertisements as the user opens the website or the application or the electronic mail or the message which offer payment for watching advertisements.

However, the mobile phone ringtones and notification tones are activated without intervention by the user. This method provides a solution to the problem caused by users' control over paid advertisement watching.

Another important problem for the advertisers is to deliver the advertisement message to the consumer when the advertisements can be best perceived by the consumers. That is the primary reason why the celebrities are casted for commercials, and the first commercial after the TV series and POP—Point of Purchase—advertisements are the most expensive advertisements. The moment when phone of a consumer rings or the consumer hears a message notification tone is one of the times when the perception system of the user and even people around the user is stimulated most or is in the most active status. Right at that moment, the method described in the invention send and/or plays the advertisement or information messages to the consumer and everybody else nearby which provides a solution for the efficiency and performance problems of the advertisement messages, providing a solution to one of the main problems by significantly improving such phenomena.

The purpose of the invention is to find a solution to the foregoing problems, remotely replace mobile phone ringtones and/or notification tones with voice and video advertisements/messages by a subscribed system (through an application which is indirectly installed on the phone), have advertisements (or messages) watched, and ensure that the users gain money, credits and alike (miscellaneous advantages) among others through such advertisements/messages without need to take any other action or make any intervention.

It ensures that when users of this system are called by other mobile phone users or notified by a notification tone from a service, voice/video advertisements (messages) are played by the phone (instead of) the phone's ringtone / notification tone without further intervention, along with management, replacement, deletion, renewal and repetition of such advertisements, further ensuring the users to gain and/or make others gain money/credits for being the user of the system. After being a user, the user will earn all of these advantages without making efforts neither for loading, playing, replacement, calculation and deletion or advertisements/messages nor for the miscellaneous advantages gained through such advertisements/messages. The user's phone becomes an advertisement channel which earns the user credits specific to the user which can be used in miscellaneous advantages.

### DESCRIPTION OF INVENTION

For application of the invention, first an advertisement management system must be created. This system ensures—through a system application which the user installs/makes available on/is transmitted to his/her phone by any means—that when the phone of the mobile phone owner is called or notified by a third person/entity, the system will change the ringtone or notification tone, and instead, play a audio/video advertisement/message which is previously, simultaneously or subsequently loaded. The person who downloads/installs/makes available/is transmitted this system on his/her phone will be a system user, playing/running the advertisements by abovementioned means. The advantage of being a system user is that the user gains and makes other to gain money, credits and other advantages from the advertisements/messages which the user allows to be played/run on his phone.

The user uses the credits which the user gains and which will provide the user miscellaneous advantages for some advantages provided to the user by the system, or transfers such credits to his/her bank account or credit card, or may use such credits in any other ways. Furthermore, the user may offer such money/credits and advantages to others; e.g. it may donate such money/credits and advantages to nongovernmental organizations through the system.

As described hereinabove, the invention involves three parties, i.e. mobile phone owner, advertisement/message/information sender and service provider.

As used in the invention;
Mobile phone user means a user who attends the system by downloading, installing, or being transmitted the described system, application on his/her mobile phone in any way,
Advertiser means a person or entity that ensures displaying of the advertisement/message, displays the message on the mobile phone,
Service provider means the person or entity who introduces those two parties on mobile phone's display, and applying and managing said invention by reaching an agreement with said parties.

For benefiting from this system, the user needs to have an application, program or system which is downloaded/installed/is transmitted on the phone and operates the said system, as well as an infrastructure and/or connection which enables downloading/installing such system, application and program on such phone. The application, program required for playing, running the audio and video messages on the smart mobile phone which will earn the user and others some advantages can be downloaded/installed/transmitted preferably through the system website or a certain source such as Google Play or App Store, or by SMS or any other means. The user can enter his personal information on such system. Such information can be used to segment the person on the system database when necessary.

When becoming a user, the user can allow the service provider to remotely change the current smart mobile phone ringtone and notification tones of the user and provide the user with miscellaneous advantages. With the information he/she provides, the user enters the database of such service provider.

The advertiser/message sender, on the other hand, becomes an advertiser member of the system, and delivers the advertisement orders to the service provider either by means of connections provided to the advertiser or directly. By providing segment information for the advertisements to be displayed, the advertiser can segment the users and mobile phones for which the advertisement message will be played. The advertiser uploads the advertisement to this system either directly or by any other means. The advertiser uploads. And the advertiser makes the payment by miscellaneous ways, including online.

The system administrator can have an administrator control dashboard by which the administrator can have access to the user information as well as the uploaded advertisements/messages. Furthermore, there will be optional dashboards which the users and the advertisers can use in line with their membership conditions. Advertisements/messages uploaded on the system can be matched up with and displayed to the suitable users according to database information. It is essential that the advertisements/messages downloaded on/transmitted to mobile phone of the user by the service provider are displayed according to a certain time parameters as determined by the service provider, the user and the advertiser. The repetition and number of displays of advertisement/message can be determined by the service provider or the advertiser under service provider's control. Following the displayed advertisements/messages, new advertisements/messages are assigned to user's phone, the old ones being deleted, and new parameters can be created, and all these operations can be managed online.

In accordance with the parameters set for the user's phone, the service provider can determine the number of suitable campaigns and the number of advertisement/message displays for each campaign. When the user is called by others or notified messages by some services, the advertisements/messages which are automatically loaded on the phone will start to play as audio or video. The user's phone now rings such loaded advertisements/messages, and the notification tones warn the user with such advertisements/messages, as well as provides the user with miscellaneous advantages.

The user earns miscellaneous advantages or credits when advertisements/messages are played on his/her phone, such earnings are accumulated in his/her account on the system, and the person can have options of benefiting from such advantages, or may have others use such earnings, or donate such earnings to certain Nongovernmental Organizations.

1. The invention is a system for directing, managing and displaying advertisements on mobile phones wherein an audio and/or video advertisement/message replaces available ringtones and notification tones through a system application which is downloaded on/installed on/transmitted to the mobile phone of the users, ensuring that phone of a user that receives a call/message plays/runs audio and/or video advertisements/messages without any intervention by the user, and the user turns his/her phone into a new channels thus earning money/credit/advantage for himself or for other third parties.

2. The system of claim 1 for directing, managing and displaying advertisements/messages on mobile phones wherein the user is a smart mobile phone user who participates in the system by installing/being transmitted the application on his/her mobile phone.

3. The system of claim 1 for directing, managing and displaying advertisements/messages on mobile phones wherein the advertiser/message sender is the person or entity that provides advertisements for being displayed on the mobile phones.

4. The system of claim 1 for directing, managing and displaying advertisements/messages on mobile phones wherein the service provider is the service provider who enables those two parties to meet on the display of user's mobile phone.

5. The system of claim 1 for directing, managing and displaying advertisements/messages on mobile phones wherein the user earns miscellaneous earns credits which can be used for miscellaneous advantages.
